(19) United States
(12) Patent Application Publication
(10) Pub. No.: US 2022/0369532 A1
(43) Pub. Date: Nov. 24, 2022

(54) GROUND WORKING APPARATUS

(71) Applicant: RUTS PLUS LIMITED, OMARAMA (NZ)

(72) Inventor: RODGER SMAILL, OMARAMA (NZ)

(73) Assignee: RUTS PLUS LIMITED, OAMARU (NZ)

(21) Appl. No.: 17/748,285

(22) Filed: May 19, 2022

(30) Foreign Application Priority Data
May 19, 2021 (NZ) 776259

(51) Int. Cl. A01B 63/24; A01B 63/00; A01B 71/02; A01B 33/02

(52) U.S. Cl. CPC A01B 63/24; A01B 63/008; A01B 71/02; A01B 33/024

(57) ABSTRACT

Disclosed is a ground working apparatus comprising a ground working apparatus having: a frame having a plurality of wheels attached; at least one removable ground working attachment supported directly or indirectly by the frame; a means which is adapted to move the at least one removable ground working attachment between a storage configuration and a ground working configuration; and a vehicle connection means; the apparatus configured such that when in use and when connected to a vehicle via the vehicle connection means movement of the attached vehicle causes the attached apparatus to move in the same direction as the attached vehicle and if the at least one removable ground working attachment is in or is moved to the ground working configuration this results in the at least one removable ground working attachment working the ground it engages with.

### FIELD OF INVENTION

The invention generally relates to a ground working apparatus. More particularly, but not exclusively the invention relates to a towable ground working apparatus with removable attachments for performing ground work.

### BACKGROUND

Landowners and general contractors typically use machines such as tractors, diggers or graders to repair damage in the ground. However, these machines are very large, expensive and/or specialised in that they do not perform multiple jobs.

It is an object of a preferred form of the present invention to go at least some way towards addressing the above problem. While this is an object of a preferred embodiment, it should not be seen as a limitation on the scope of the invention as claimed. The object of the invention per se is simply to provide the public with a useful choice.

The term “comprising” and derivatives thereof, e.g. “comprises”, if and when used herein in relation to a combination of features should not be taken as excluding the possibility that the combination may have further unspecified features. For example, a statement that an arrangement “comprises” certain parts does not mean that it cannot also, optionally, have additional parts.

### SUMMARY OF THE INVENTION

According to one aspect of the invention there is provided a ground working apparatus comprising:
a frame having a plurality of wheels attached;
at least one removable ground working attachment (e.g. a road conditioner, a grading and retrieving attachment etc) supported directly or indirectly by the frame;
a means which is adapted to move the at least one removable ground working attachment between a storage configuration and a ground working configuration (e.g. a winch); and
a vehicle connection means (e.g. a towing coupling);
   the apparatus configured such that when in use and when connected to a vehicle via the vehicle connection means movement of the attached vehicle causes the attached apparatus to move in the same direction as the attached vehicle and if the at least one removable ground working attachment is in or is moved to the ground working configuration this results in the at least one removable ground working attachment working the ground it engages with.

Preferably having at least two removable ground working attachments such that in use a user is able to change the ground working attachment depending on the ground work that they wish the apparatus to perform.

Preferably the at least one removable ground working attachment is a grading attachment, a levelling attachment, a retrieving attachment, a road conditioning attachment or a rut filling attachment.

Preferably the frame is adapted such that it can support two removable ground working attachments directly or indirectly at the same time.

Preferably the vehicle connection means is a towing attachment which is pivotally connected to the frame.

Preferably the means to move the ground working attachment between a storage configuration and a ground working configuration is a winching means which is supported directly or indirectly by the frame.

Preferably the winching means comprises a front winch and a rear winch both of which being adapted to be controlled remotely.

Preferably the at Least one removable ground working attachment is adapted to releasably engage directly or indirectly with the frame.

Preferably the at least one removable ground working attachment is adapted to releasably engage directly or indirectly with the means which is adapted to move the at least one ground working attachment between a storage configuration and a ground working configuration.

Preferably the apparatus has a ground working attachment support which is pivotally connected to the frame and is adapted to releasably engage with the at least one removable ground working attachment.

Preferably the apparatus has pivotable ground working attachment support arms which are pivotally connected to the frame and are adapted to releasably engage with the at least one removable ground working attachment.

Preferably the at least one removable ground working attachment has at least one blade attached directly or indirectly to a blade support means which is adapted to releasably engage with the frame of the apparatus either directly or indirectly and also adapted to releasably engage directly or indirectly with the means which is adapted to move the at least one removable ground working attachment between a storage configuration and a ground working configuration such that in use a user is able to move the at least one blade between a storage configuration and a ground working configuration via the means.

Preferably the attachment has a left blade with a front end and a rear end and a right blade with a front end and a rear end and the blades are attached directly or indirectly to the blade support means and wherein there is an opening between the two rear ends of the blades.

Preferably the attachment further having a middle blade attached directly or indirectly to the blade support.

Preferably wherein the blade or blades have a plurality of ground engaging teeth on a ground engaging edge of the blade.

Preferably the attachment has an adjustable rear dragging or levelling means which is attached directly or indirectly to the blade support means.

More preferably the adjustable rear dragging or levelling means is adapted such that the rear dragging or levelling means can be moved between a stored configuration and a dragging or levelling configuration and when in the dragging or levelling configuration this closes the opening between the two rear ends of the left and right blades.

Preferably the blade support means has attachment members which are adapted to releasably engage with pivotable ground working attachment support arms which are pivotally attached to the frame.

Preferably the blade support means has an attachment means which is adapted to releasably engage with the means which is adapted to move the at least one ground working attachment between a storage configuration and a ground working configuration.

Preferably wherein the at least one removable ground working attachment has a plurality of rotatable ground engaging blades adapted to dislodge the ground and wherein the blades are supported by a rotatable ground engaging blade support means which is adapted to releasably engage with the frame directly or indirectly and to releasably engage directly or indirectly with the means which is adapted to move the at least one removable ground working attachment between a storage configuration and a ground working configuration such that in use a user is able to move the plurality of rotatable ground engaging blades between a storage configuration and a ground working configuration.

Preferably the attachment has at least one ground scraping member which is attached directly or indirectly to the rotatable ground engaging blade support means.

Preferably the rotatable ground engaging blades have a plurality of ground engaging teeth.

Preferably the rotatable ground engaging blade support means has at least one attachment member which is adapted to releasably engage with a pivotable ground working attachment support which is pivotally connected to the frame and wherein the ground working attachment support also has an attachment member adapted to releasably engage with the means which is adapted to move the at least one ground working attachment between a storage configuration and a ground working configuration.

In a second aspect of the invention there is provided a ground working apparatus comprising:
a frame having a plurality of wheels attached;
two removable ground working attachments supported directly or indirectly by the frame;
a means which is adapted to move one or both of the ground working attachments between a storage configuration and a ground working configuration; and
a vehicle connection means;
   the apparatus configured such that when in use and when connected to a vehicle via the vehicle connection means movement of the attached vehicle causes the attached apparatus to move in the same direction as the attached vehicle and this also results in one or both of the removable ground working attachments working the ground they engage if they are in the ground working configuration.

In a third aspect of the invention there is provided a removable ground working attachment for use with a ground working apparatus having a left blade with a front end and a rear end, a right blade with a front end and a rear end with an opening between the rear ends and an adjustable rear blade which is adapted to move between a stored configuration and a dragging or levelling configuration which closes the opening between the two rear ends of the left and right blades, the blades all being attached directly or indirectly to a blade support means, the blade support means being adapted to releasably engage with the frame of an apparatus directly or indirectly and being adapted to releasably engage with the means which is adapted to move the at least one ground working attachment between a ground working configuration and a storage configuration such that in use a user is able to move the blades between a ground working configuration and a storage configuration.

Preferably the attachment has a middle blade attached directly or indirectly to the blade support

Preferably the left, right and middle blades have a plurality of ground engaging teeth on a ground engaging edge.

In a fourth aspect of the invention there is provided a removable ground working attachment for use with a ground working apparatus having a plurality of rotatable ground engaging blades adapted to dislodge the ground and wherein the blades are supported by a rotatable ground engaging blade support means which is adapted to releasably engage with the frame of an apparatus directly or indirectly and is also adapted to releasably engage directly or indirectly with the means which is adapted to move the at least one ground working attachment between a ground working configuration and a storage configuration such that in use a user is able to move the rotatable ground engaging blades between a ground working configuration and a storage configuration.

Preferably the attachment has at least one ground scraping member which is attached directly or indirectly to the rotatable ground engaging blade support means.

Preferably the ground engaging rotatable blades have a plurality of ground engaging teeth.

In a fifth aspect of the invention there is provided a method of working the ground using the previously described apparatus.

These and other features, objects and advantages of the present invention will be readily apparent to persons of ordinary skill in the art upon reading the entirety of this disclosure, which includes the accompanying drawings and claims.

### BRIEF DESCRIPTION OF THE DRAWINGS

Some preferred embodiments of the invention will now be described by way of example and with reference to the accompanying drawings, of which:

FIG. 1 is a side view of a ground working apparatus with no ground working attachments connected to it;

FIG. 2 is a front view of the ground working apparatus;

FIG. 3 is a rear view of the ground working apparatus;

FIG. 4 is a top perspective view of the ground working apparatus;

FIG. 5 is a bottom view of the ground working apparatus;

FIG. 6 is a top view of the ground working apparatus with the winch cover removed;

FIG. 7 is a rear view of a removable spinning blade/disc attachment which forms part of a removable rut filling attachment;

FIG. 8 is a bottom view of the removable spinning blade/disc attachment;

FIG. 9 is a top front perspective view of the removable spinning blade/disc attachment;

FIG. 10 is a perspective view of a catch blade attachment which forms part of a removable rut filling attachment;

FIG. 11 is a front view of the catch blade attachment;

FIG. 12 is a rear view of the catch blade attachment;

FIG. 13 is a perspective view of the ground working apparatus with the rut filling attachment attached and is in a ground working configuration and the dragging blade is in a dragging position;

FIG. 14 is a side view of the ground working apparatus with the rut filling attachment attached and is in a ground working configuration and dragging blade is in a dragging position;

FIG. 15 is a rear view of the ground working apparatus with the rut filling attachment attached and is in a ground working configuration and the dragging blade is in a dragging position.

FIG. 16 is a front view of a removable grading and retrieving attachment;

FIG. 17 is a top view of the removable grading and retrieving attachment;

FIG. 18 is a side view of the removable grading and retrieving attachment;

FIG. 19 is a perspective view of the ground working apparatus with the removable grading and retrieving attachment attached and is in a ground working configuration and the dragging blade in a storage position;

FIG. 20 is a side view of the ground working apparatus with removable grading and retrieving attachment attached and is in a ground working configuration and the dragging blade in a storage position;

FIG. 21 is a perspective view of a removable road conditioning attachment;

FIG. 22 is a top view of the removable road conditioning attachment;

FIG. 23 is a perspective view of the ground working apparatus with the removable road conditioning attachment attached and is in a ground working configuration and wherein the dragging blade is in a storage position;

FIG. 24 is a rear view of the ground working apparatus with the removable road conditioning attachment attached and is in a ground working configuration and the dragging blade is in a storage position;

FIG. 25 is a perspective view of a removable spinning blade/disc attachment which forms part of an alternative removable road conditioning attachment;

FIG. 26 is a rear view of the removable spinning blade/disc attachment which forms part of an alternative removable road conditioning attachment;

FIG. 27 is a perspective view of an alternative removable road conditioning attachment which can be used in combination with the removable spinning blade/disc attachment shown in FIGS. 25 and 26;

FIG. 28 is a perspective view of the ground working apparatus with the alternative removable road conditioning attachment attached and is in a ground working configuration and the dragging blade is in a stored position;

FIG. 29 is a side view of the ground working apparatus with the alternative removable road conditioning attachment attached and is in a ground working configuration and the dragging blade is in a stored position;

FIG. 30 is a rear view of the ground working apparatus with the alternative removable road conditioning attachment attached and is in a ground working configuration and the dragging blade is in a stored position;

FIG. 31 is a rear view of a removable spinning blade/disc attachment with teeth which forms part of an alternative removable road conditioning attachment;

FIG. 32 is a bottom view of the removable spinning blade/disc attachment with teeth which forms part of an alternative removable road conditioning attachment; and

FIG. 33 is a perspective view of the ground working apparatus with the alternative removable road conditioning attachment attached and is in a ground working configuration and the dragging blade is in a stored position.

### DETAILED DESCRIPTION

The present invention relates to a ground working apparatus with removable ground working attachments/devices with each attachment/device designed for a specific task e.g. grading, levelling, retrieving soil from under fence lines on dairy farms, filling in centre pivot wheel ruts, filling in potholes and corrugations on uneven surfaces such as roads and tracks etc. Reference to ground throughout the specification includes any surface of the earth such as paddocks, soil and also include roads (e.g. gravel, dirt and asphalt etc).

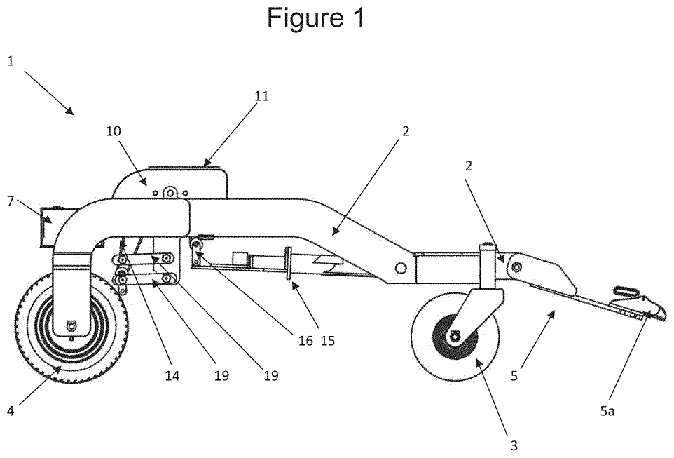

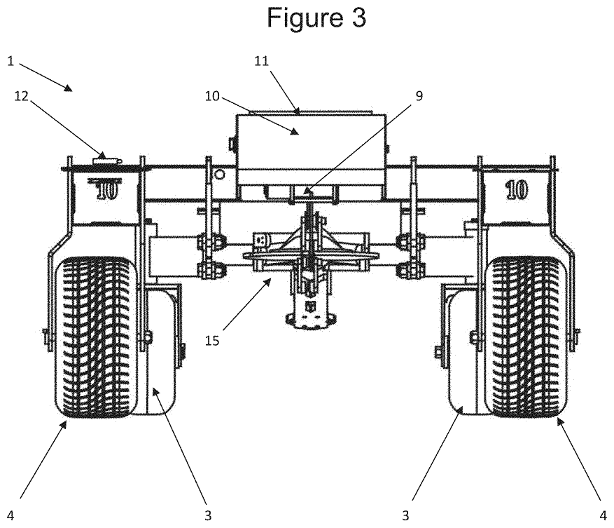

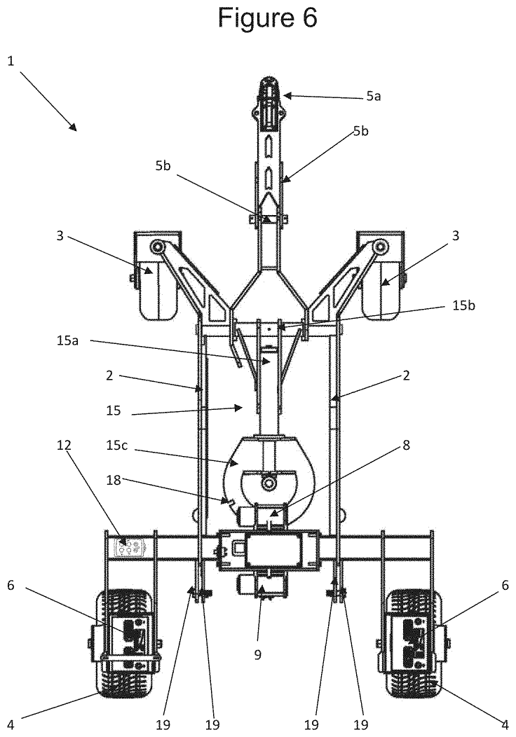

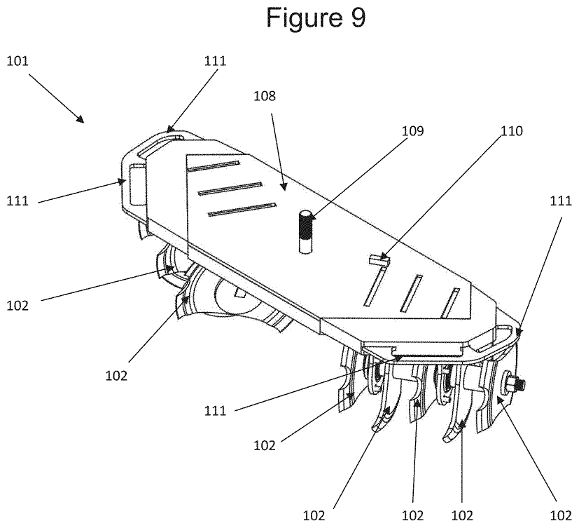

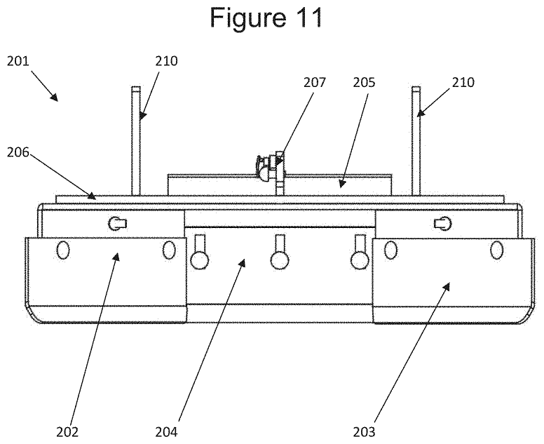

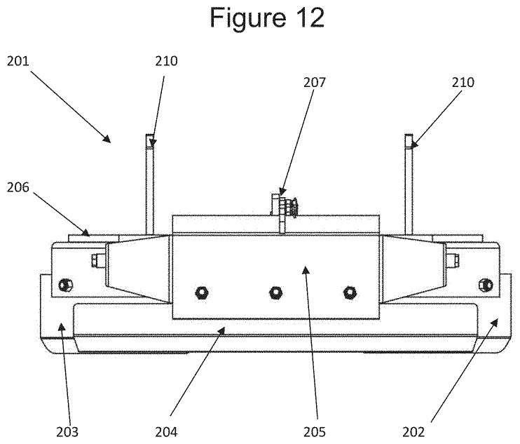

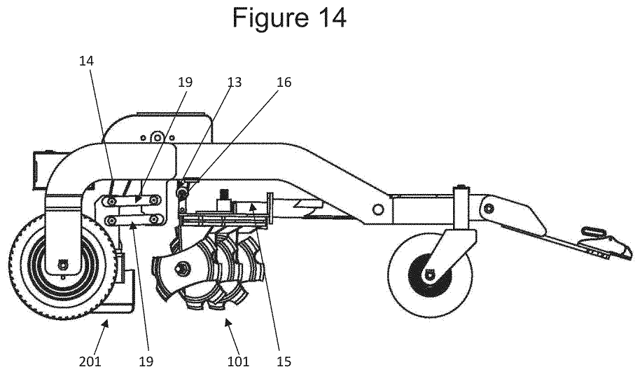

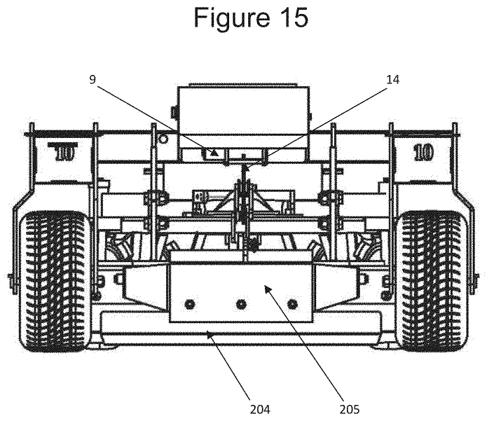

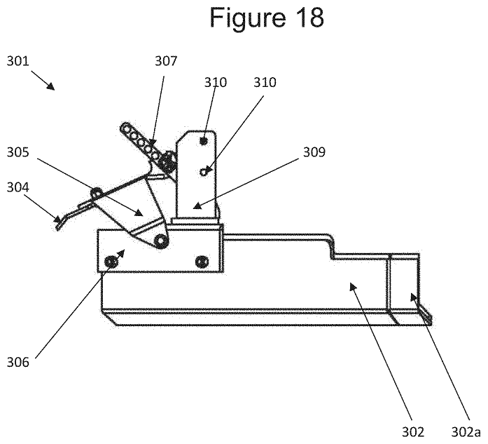

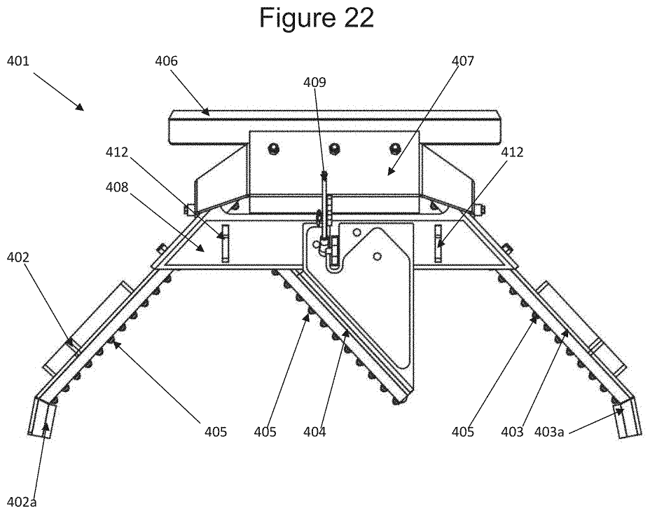

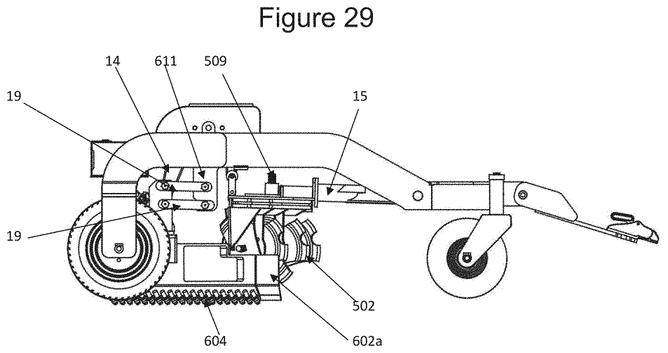

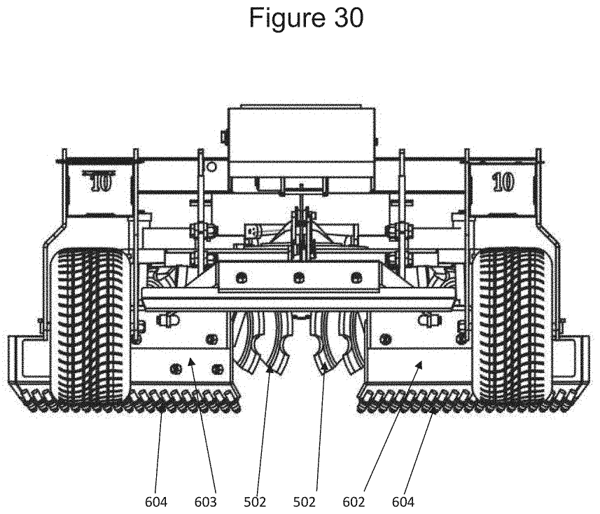

A number of different embodiments have been described below and in reference to FIGS. 1-33 but it should be understood the design and aesthetic features of the ground working apparatus and removable ground working attachments and method of using them may be changed from those exemplified without departing from the functional aspects of the invention.

FIGS. 1-6 show a ground working apparatus 1 with no ground working attachments connected to it. The apparatus 1 has a frame/main body 2 made preferably from steel or other suitable materials and is adapted such that different types of removable ground working attachments can be removably attached to it and the apparatus 1. The frame 2 supports the ground working attachments either directly or indirectly. The apparatus 1 shown can have either one or two ground working attachments at a time attached to it e.g. the frame 2 can support two ground working attachments. The apparatus 1 has a pair of front pivoting castor wheels 3, which turn in the same arc as the vehicle that tows, pulls or drags the apparatus 1 when in use. As can be seen the apparatus 1 also has a larger pair of treaded rear wheels 4. The wheels 3, 4 support all of the weight of the frame 2. Those skilled in the art will appreciate that the location, types and number of wheels 3, 4 may differ however in the most preferred embodiment of the invention there are only four wheels 3, 4 like that shown in the figures. In a preferred embodiment of the invention the apparatus 1 is about 2590 mm in length, about 897 mm in height and about 1085 mm in width at the front (from wheel 3 to wheel 3) and 1460 mm in width at the rear (from wheel 4 to wheel 4). However, it will be appreciated that the apparatus 1 is not limited to these dimensions. The apparatus 1 is preferably sized such that it can be transported on a trailer.

The front of the apparatus 1 has pivoting towing attachment 5 which attaches to towing vehicle when in use. The attachment 5 has a trailer coupling 5a at one end which attaches to the tow ball of a towing vehicle and the other end 5b of the attachment 5 is pivotally connected via a pivoting member 5c to the frame 2 of the apparatus 1. The towing attachment 5 is able to pivot on a tow ball when attached and also able to pivot vertically and horizontally on the frame 2 which takes all the weight off the towing vehicle keeping the four wheels 3, 4 of the apparatus 1 on the ground regardless of the conditions. The attachment 5 can be pivoted backwards towards the apparatus 1 for storage. The apparatus 1 can be towed by ATV's, UTV's, 4×4's, tractors, cars and the like. In an alternative embodiment the towing attachment can form part of the frame 2 and in other embodiments the means of attachment to a towing vehicle may differ. In some further embodiments the attachment towing coupling end 5a may have a safety chain and in other embodiments the apparatus 1 may have rear lights (e.g. brake lights and indicators) and also a towing wiring kit which connects the electrics and lights from the towing vehicle to the apparatus 1 and the lights which illuminate the apparatus 1 when the towing vehicle is connected to the apparatus 1 and is braking or indicating etc. In preferred embodiments the towing attachment 5 is removable and there may be a number of removable towing attachments 5 which vary in size which can be used. The towing attachment 5 is preferably about 630 mm in length (so when in the storage position the apparatus is around 1990 mm in length), however, it is not limited to this size. It will be appreciated by those skilled in the art that other vehicle connection means instead of a towing attachment member may be used. While the most preferred embodiments of the invention involved a vehicle connection means at the front of the apparatus which connects to a vehicle and is pulled by the apparatus it will be appreciated in some embodiments the apparatus may be pushed instead of pulled e.g. the rear frame may be adapted to receive the front of a vehicle such as a tractor or bobcat etc or may have a vehicle attachment means at the rear to enable attachment to a vehicle to push it. In further embodiments the vehicle connection means forms part of the frame 2.

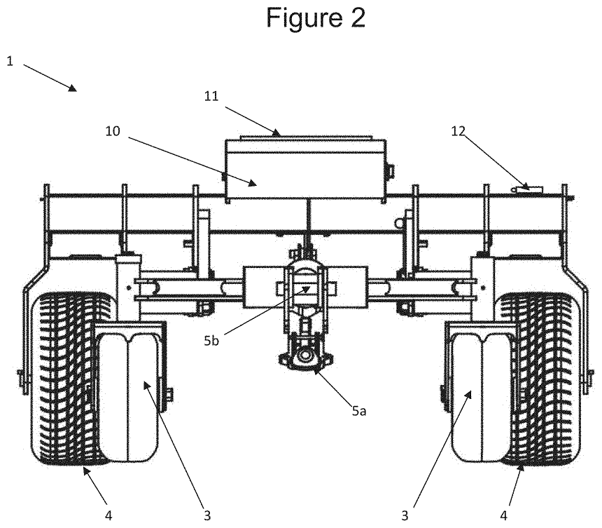

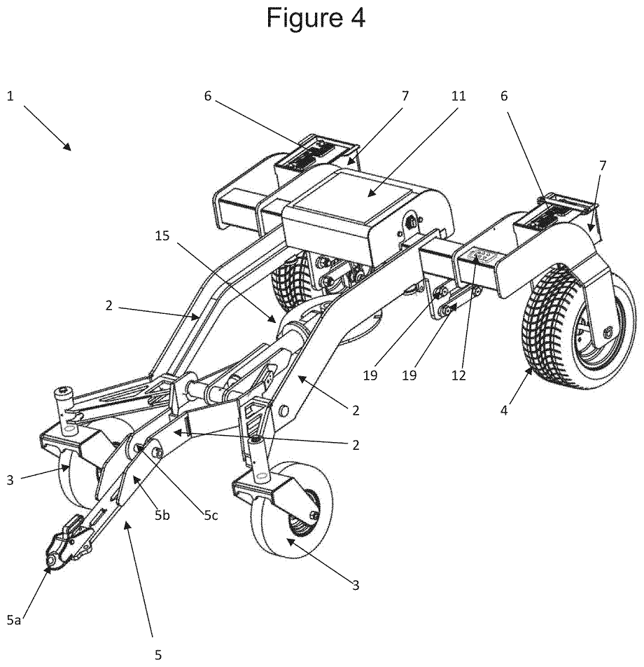

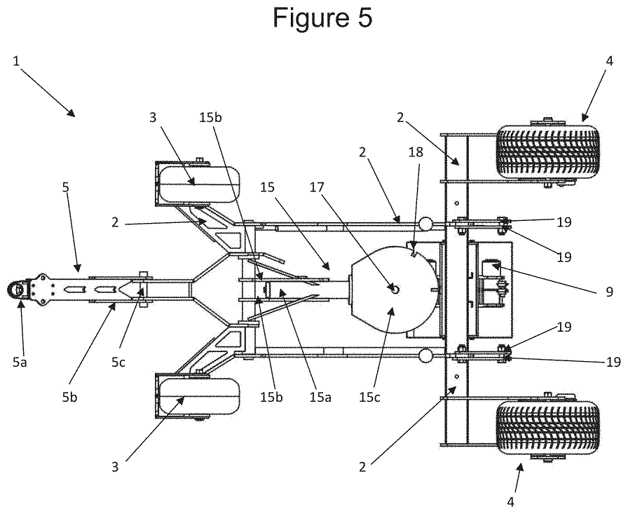

The apparatus 1 also has a pair of batteries 6 which are preferably 12 volt solar-powered batteries which sit inside two battery boxes 7 on each side of the apparatus 1 and are supported by the frame 2 and in some embodiments the boxes 7 form part of the frame 2. It will be appreciated that in some embodiments the batteries 6 can vary in type, location and number. The batteries 6 power a front winch 8 and a rear winch 9 (both winches 8, 9 also preferably 12 volt) and these winches 8, 9 can be seen in FIGS. 4 and 5 and are located under a removable winch cover 10 with solar panels 11 on its roof to power the batteries 6. The winches 8, 9 are supported and attached to the frame 2. The removable winch cover 10 is preferably about 462 mm in length, 420 mm in width and 197 mm in height but is not limited to this. The apparatus 1 also has a wireless remote control 12 (shown in FIGS. 2, 3, 4 and 6) and associated receiver which controls the winches 8, 9 and is able to power either one of them or both of them on and off and to wind them in or out. The winches 8, 9 each have a winch cable 13, 14 which can wind in and out to raise or lower any attachments which are attached to them when in use. It will be appreciated that other means of controlling the winches 8, 9 e.g. mobile phone applications, buttons located on or integrated into the frame, a wired remote control etc, may be used as can other means of powering the winches 8, 9 e.g. powered by a power cable from the towing vehicle etc. In some embodiments, the apparatus 1 may have a single winch and in other embodiments it may have more than two winches and in an alternative embodiment, other means (instead of a winch) of raising and lowering the ground working attachments may be used e.g. hydraulics or manually etc. The means (e.g. the winches 8, 9) of raising and lowering the attachments moves the attachments between a ground working configuration and a stored or transport configuration. In some embodiments the winches 8, 9 support either directly or indirectly the ground working attachment.

Located in the centre of the apparatus 1 is a pivoting ground working attachment support 15 with one end 15a having a pivoting attachment means 15b which attaches to the frame 2 and also having one generally circular end 15c. The apparatus 1 also has an attachment member 16 such as a D-link connected to the circular end 15c of the support 15 and this is attached to winch cable 13 which is connected to the front winch 8. As shown in FIG. 5 the circular end 15c of the pivoting support 15 has an aperture 17 for receiving an attachment member of a ground working attachment (e.g. a spinning blade/disc attachment) and also a means 18 for receiving another attachment member of a ground working attachment. In further embodiments the shape and size of the pivoting ground working attachment support 15 may differ and in some embodiments the support member 15 may be pivotally connected to the frame directly instead of via a pivoting attachment means 15b.

The apparatus 1 also has four pivotable ground working attachment support arms 19 (two on each side) connected to the frame 2 which are able to releasably attach to a ground working attachment. In some embodiments the frame 2 may have magnetic limit switches which stop the arms 19 and any attached ground working attachment from lifting up too far so that the user does not need to look behind them when in use. In some embodiments, instead of the pivoting ground working attachment support 15 and pivotable support arms 19 the removable ground working attachments may be attached to the rest of the apparatus 1 by other means.

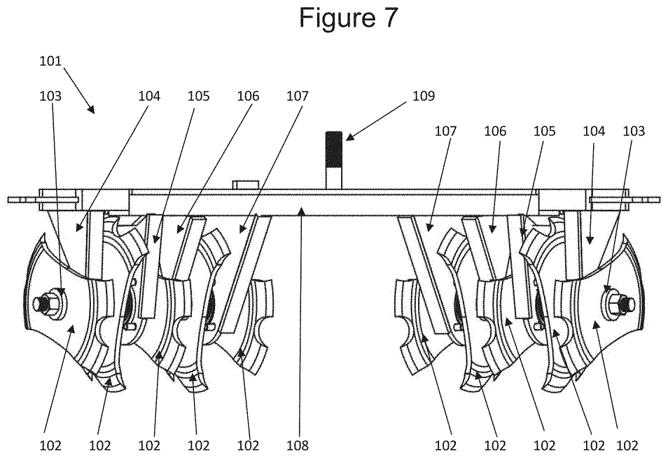

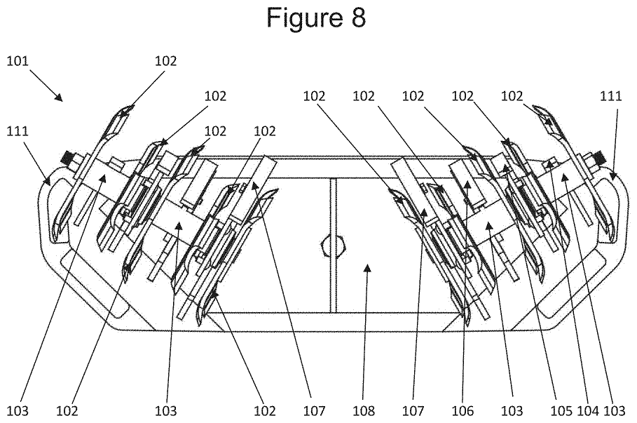

FIGS. 7-9 show a removable ground working attachment namely a removable spinning blade/disc attachment 101 which forms part of a removable rut filling attachment. As shown the attachment 101 has ten rotating blades/discs 102 with five on each side. In another embodiment there are eight rotating blades 102 with four on each side and in other embodiments there may be more or fewer blades. The blades/discs 102 are made from 10 mm thick Hardox 450 steel wear plate and are designed to penetrate deep into the soil when in use. The blades/discs 102 are about 329 mm in length and about 192 mm in height however, they are not limited to this size or shape. The blades 102 have an aperture through which an elongated rotating rod (or part of the rod) 103 passes through and are secured at each end by securing means e.g. a bolt and a metal plate etc. It will be appreciated that other types of rotating members may be used instead of the rotating rod 103 shown and it may be secured to the blades 102 in other suitable ways and in some embodiments the blades 102 may be permanently attached to the rotating member 103. The attachment 101 also has four central links/scrapers 104, 105, 106, 107 of differing sizes and shapes on each side. The rod 103 only passes through two of the central links/scrapers 105, 107 and these links/scrapers 105, 107 have bearings housed within them. One edge/face of the links/scrapers 104, 105, 106, 107 is adapted/shaped for scraping the ground. The links/scrapers 104, 105, 106, 107 are preferably bolted to the bottom of a plate member 108 of the attachment 101 however, those skilled in the art will appreciate that they can be attached to the plate member 108 in other ways In some embodiments there may be more or less than four links/scrapers 104, 105, 106, 107 and the number of housed bearings may also vary. The plate member 108 is preferably about 370 mm wide and about 1247 in length, however it can come in different shapes and sizes and is preferably made from steel although it may be made from any suitable materials. The attachment 101 also has an attachment member 109, a movable clamping means 110 and as can be seen the attachment 101 also has four handles 111 to assist users with lifting/attaching/removing the attachment 101. The attachment 101 is connected to the rest of the apparatus 1 via the attachment member 109 shown in FIGS. 7 and 8 which protrudes upwardly from the roof of the plate member 108 of the attachment 101. The attachment member 109 passes through the aperture 17 in the pivotable support 15 and then is secured/attached via a bolt or the like. The attachment 101 also has a movable clamping means 110 and this engages with part 18 of the pivotable support 15 in use. It will be appreciated that the attachment 101 can come in various shapes and sizes and in alternative embodiments it may be connected to the pivotable support 15 by other means. The attachment 101 can be moved between a ground working configuration and a stored or transport configuration by using the winch 8. In some embodiments the attachment means and members 109, 110 can form part of the plate member 108.

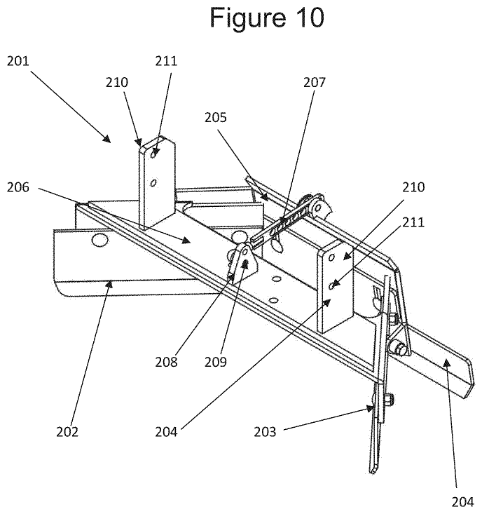

FIGS. 10-12 shows another removable ground working attachment namely a catch blade attachment 201 which is preferably used in combination with the pivot rut rotating blade attachment 101. As shown the attachment 201 has a left retrieving blade 202 and a right retrieving blade 203 both blades 202, 203 having a front end and a rear end and wherein there is an opening between the rear ends of the blades 202, 203. The attachment 201 also has a dragging/levelling blade 204 attached to a moveable rear plate member 205 which can be can be moved from a dragging configuration to close the opening between the blades 202, 203 or can be moved to a stored/transport configuration. The attachment 201 also has a cross plate member 206, which is pivotally connected to the rear plate member 205 and also connected to the blades 202, 203. The attachment 201 also has a means to adjust and lock 207 the rear plate member 205 and the dragging blade 204, a winch cable attachment means 208 with apertures 209 for receiving a winch cable 14 from the rear winch 9 and a pair of attachment members 210 with apertures 211 for attaching to the pivotable support arms 19 of the apparatus 1. The attachment 201 is preferably about 1048 mm in width and 484 mm in height however it will be appreciated that the catch blade attachment 201 can come in different shapes and sizes. The attachment 201 can be moved between a ground working configuration and a stored or transport configuration by using the winch 9. In some embodiments the attachment means and members 208, 209, 210, 211 can form part of the plate member 206.

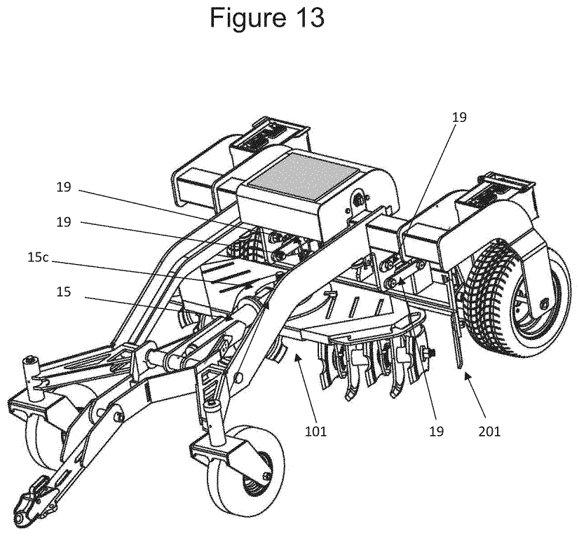

FIGS. 13-15 illustrate the attachments 101, 201 when attached to the rest of the apparatus 1. As can be seen attachment 101 is attached to the circular end 15c of the pivotable support 15 via the attachment member 109 and clamping means 110 and is supported by the winch cable 13 (from the front winch 8) which attaches to the attachment member 16 on the pivotable support 15. Attachment 201 is connected via the attachment members 210 which are fastened to the support arms 19 of the apparatus 1 and also via winch cable 14 (from the rear winch 9) which is connected to the winch cable attachment means 208. In these figures the levelling blade 204 and rear plate 205 and of the attachment 201 are in the levelling/dragging position. The blade 204 and rear plate 205 can be moved/adjusted to the stored position so the blade 204 is not contacting the ground and locked in place by the adjusting and locking means 207. It will be appreciated that the attachments 101, 201 may be connected to the apparatus by other means.

The attachment 101 is designed to float over the soil using only the weight of the attachment 101 following the uneven ground surfaces, always in contact with the ground and will ride over large objects such as rocks, all without the need for any adjustment by the operator/user. In use the user connects the apparatus 1 to the towing vehicle via the towing attachment 5 and coupling 5a and then drops/lowers the attachment 101 to the ground such that it is in the ground working configuration via the remote control 12 and then tows the apparatus 1 over the ground that they want worked. At any one time there are only five blades 102 in the ground and as they are lifting out of the ground the other five 102 then penetrate maximising the downward force over a smaller blade area as they rotate forward under momentum, pulled by a tow vehicle they penetrate the ground cutting away the sidewalls of the pivot rut twisting and ripping out sods, roots, stones, soil and other material all to be mixed back into the wheel rut. They are designed approximately 90 degrees to each other to leave undisturbed grass and soil on both sides of the wheel rut, this enables the apparatus 1 to operate without leaving bare depressions on both sides of the rut. This reduces weed growth and keeps the land level. The attachment 101 is lifted up and down by activating the wireless remote control 12 that operates the electric winch 9 and lifts the pivotable support 15 and the attachment 101. It is able to lift the attachment 101 high enough that when a fence is pinned down the apparatus 1 can be towed over the fence. Attachment 201 is used to windrow the chopped material back into the wheel rut and the adjustable hinged blade/gate 204 at the rear can be used to drag loose material back into larger holes. The typical way to fill in ruts such as from a centre pivot irrigator is to fill the ruts with gravel. Using the apparatus 1 and attachments 101, 201 to fill in ruts is much faster and cheaper.

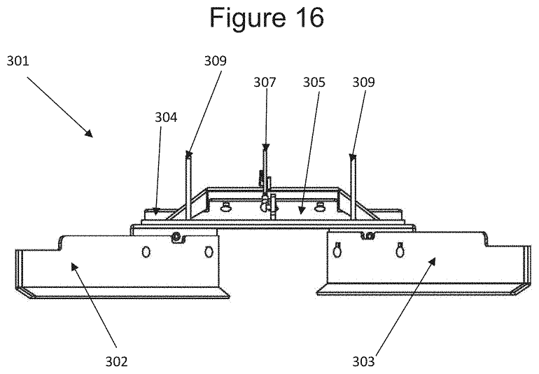

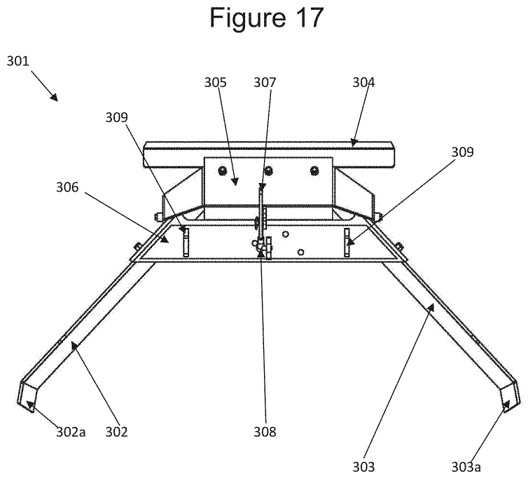

FIGS. 16-18 show another removable ground working apparatus attachment namely a grading and retrieving attachment 301. As shown the attachment 301 has a left retrieving blade 302 and a right retrieving blade 303 similar to the catch blade attachment 201 previously described however the ends of the blades 301, 302 are longer and the ends/tips 301a, 302a of the blades 301 and 302 are angled inwards as can be seen in FIG. 17. The attachment 301 also has a dragging/levelling blade 304 attached to a moveable rear plate member 305 and this can be can be moved from a dragging configuration or can be moved to a stored configuration like shown in these figures. The attachment 301 also has a cross plate member 306 which is pivotally connected to the rear plate member 305 and is also connected to the blades 302, 303. The apparatus 301 also has a means to adjust and lock 307 the rear plate member 305 and the dragging blade 304, a winch cable attachment means 308 with apertures for receiving a winch cable 14 from rear winch 9 and a pair of attachment members 309 with apertures 310 for attaching to the pivotable support arms 19 of the apparatus 1. The attachment 301 is preferably about 1805 mm in width, 484 mm in height although it will be appreciated that the attachment 301 can come in different shapes and sizes. The attachment 301 can also be moved between a ground working configuration and a stored or transport configuration by using the winch 9. In some embodiments the attachment means and members 308, 309, 310 can form part of the plate member 306.

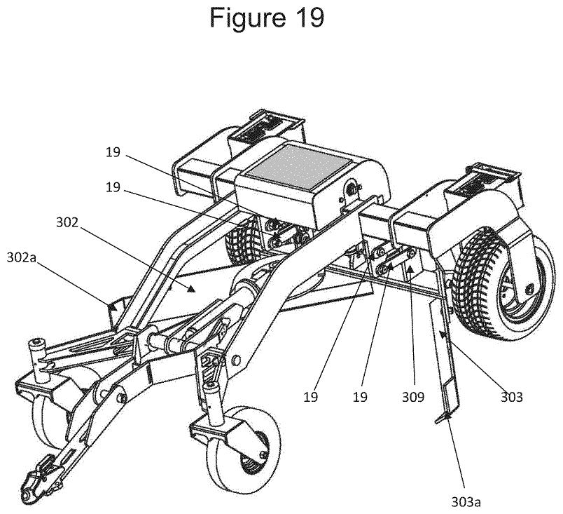

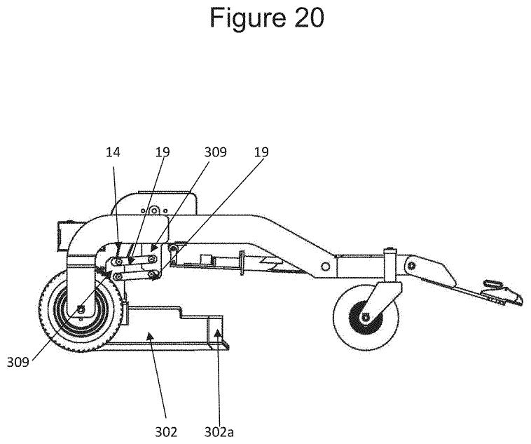

Shown in FIGS. 19 and 20 is the attachment 301 when it is connected to the rest of the apparatus 1 via the attachment members 309 which are fastened to the support arms 19 of the apparatus 1 and also via winch cable 14 which is connected to the winch cable attachment means 307. In these figures the levelling blade 304 and rear plate 305 and of the attachment 301 have been moved to a stored position so the blade 304 is not contacting the ground and locked in place by the adjusting and locking means 307. It will be appreciated that the blade 304 and rear plate 305 can be moved to the dragging/levelling position and locked into place if needed. It will also be appreciated that the attachments 301 may be connected to the apparatus 1 by other means. The attachment 301 may be used for retrieving material from under dairy lane fences and the sides of roads. The blades 302, 303 windrow material far enough away from fences that it can be scooped up and taken away or dragged back into the paddock or spread out thinly on the lane. The attachment 301 is able to level, drag materials, windrows and can also grad (e.g. restoring drive surface and drainage etc). The attachment 301 can be used on roads and tracks e.g. for grading material back in from the sides of dirt and paved road areas where loose material has been pushed out from vehicle wheels. The apparatus 1 and attachment 301 has an advantage over other machines currently being used on roads due to the tiny amount of area taken up on the tar seal surface by the apparatus 1 and attachment 301 which is less than a bicycle lane meaning that the grading can be done in a convoy with the apparatus 1, a roller then a road sweeper so there is no need to block off half the road with road cones or the need for extra staff controlling traffic as the apparatus 1 and attachment 301 uses only the one blade either 302 or 303 when doing this.

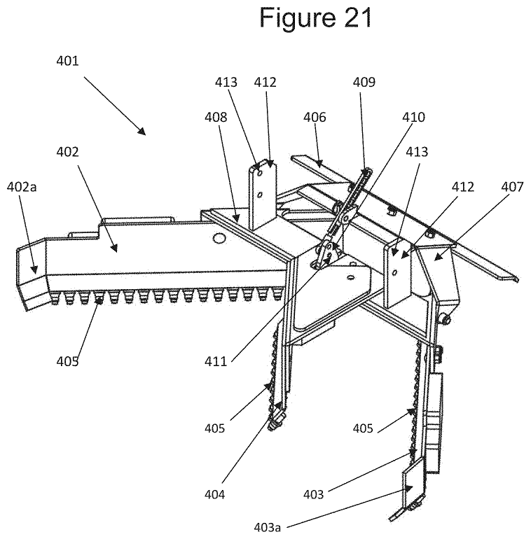

FIG. 21 shows another removable ground working apparatus attachment namely a road conditioning attachment 401. As shown the attachment 401 has a left blade 402 with an angled end/tip 402a, and right blade 403 with an angled end/tip 403a, and a centre blade 404. As can been seen all of the blades 402, 403, 404 have a number of teeth 405 preferably made from carbide. The attachment 401 also has an adjustable floating levelling blade/gate 406 attached to a moveable rear plate member 407 which can be moved from a dragging levelling configuration or can be moved to a stored configuration when not in use like shown. The attachment 401 also has a cross plate member 408, which is pivotally connected to the rear plate member 407 and also is connected to the blades 402, 403, 404. The attachment 401 also has a means to adjust and lock the levelling blade/gate 409, a winch cable attachment means 410 with apertures 411 for receiving a winch cable 14 and a pair of attachment members 412 with apertures 413 for attaching to the pivotable support arms 19 of the apparatus 1. The attachment 401 is preferably about 1665 mm in width and 545 mm in height although it will be appreciated that the attachment 401 can come in different shapes and sizes. The attachment 401 can also be moved between a ground working configuration and a stored or transport configuration by using the winch 9. In some embodiments the attachment means and members 410, 411, 12, 413 can form part of the plate member 408.

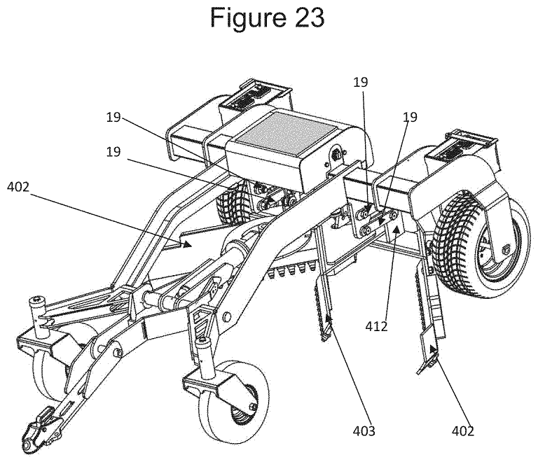

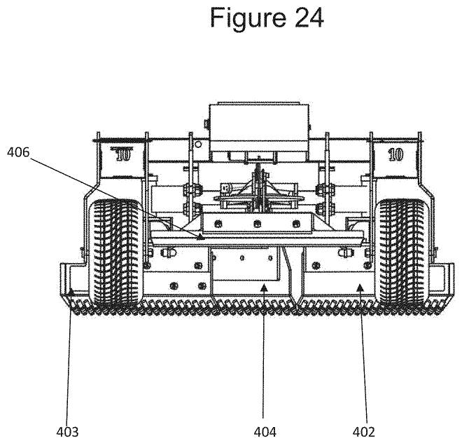

Illustrated in FIGS. 23 and 24 is the road conditioning attachment 401 when attached to the rest of the apparatus 1 via the pivotable support arms 19 and winch cable 14. In these figures the levelling blade/gate 406 has been moved to a stored configuration and locked in place by the adjusting and locking means 409. It will be appreciated that the attachment 401 may be connected to the apparatus 1 by other means. The road conditioning attachment 401 is used for conditioning gravel and dirt roads and cutting to the bottom of corrugations and potholes. The attachment 401 levels, crowns and mixes the ripped up road material and then spreads the material out evenly behind the apparatus 1. This is achieved by the adjustable floating levelling gate 406 at the rear that can also be pre-set on an angle to crown the road surface to help with water runoff. In use typically no adjustment is needed and the attachment 401 as it just needs to be placed on the ground and the towing vehicle can drive forward. When in use with this attachment 401 the apparatus 1 is easy to manoeuvre in tight spaces and the road can be conditioned and levelled out in one pass by the apparatus 1 and attached road conditioning attachment 401.

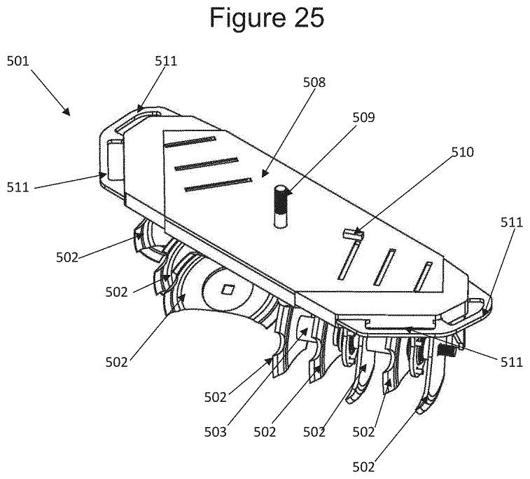

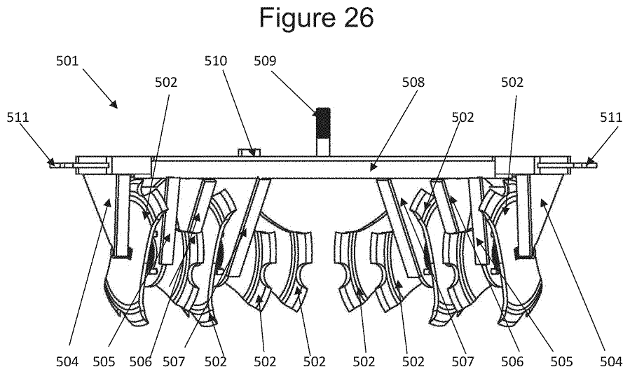

FIGS. 25 and 26 show another removable ground working attachment namely a removable spinning blade/disc attachment 501 which forms part of an alternative embodiment of a road conditioning attachment. As shown the attachment 501 has ten rotating blades/discs 502 with five on each side. In another embodiment there are eight rotating blades 502 with four on each side and in other embodiments there may be more or fewer blades 502. The blades/discs 502 are made from 10 mm thick Hardox 450 steel wear plate and are about 329 mm in length and 192 mm in height however are not limited to this size or shape. The blades 502 have an aperture through which an elongated rotating rod (or part of the rod) 503 passes through and is secured at each end with securing means e.g. with a plate and a bolt etc. It will be appreciated that other types of rotating members may be used instead of the one shown 503 and it may be secured to the blades 502 in other suitable ways and in some embodiments the blades 502 may be permanently attached to the rotating member. The attachment 501 also has four central links/scrapers 504, 505, 506, 507 on each side. The rod 503 only passes through two of the central links/scrapers 505, 507 and these links 505, 507 have bearings housed within them. One edge or face of the links 504, 505, 506, 507 is adapted/shaped for scraping the ground. The links 504, 505, 506, 507 are bolted to the bottom of a plate member 508 of the attachment 501. However, those skilled in the art will appreciate that they can be attached to the plate member 508 in other ways and in some embodiments there may be more or less than four links/scrapers 504, 505, 506, 507 and the number of housed bearings may also vary. The attachment 501 also has attachment member 509, a movable clamping means 110 and as can be seen the attachment 501 has four handles 511 to assist with lifting/attaching/removing it. The plate member 508 is preferably about 370 mm wide and about 1247 in length, however it can come in different shapes and sizes and is preferably made from steel although it may be made from any suitable materials. The attachment 501 is similar to attachment 101 however the arrangement of the blades 502 and links 504, 505, 506, 507 is different. The attachment 501 is connected to the rest of the apparatus 1 via the attachment member 509 which protrudes upwardly from the roof of the plate member 508. The attachment member 509 passes through the aperture 17 in the pivotable support 15 and is then secured/attached via a bolt or the like. The attachment 501 also has a movable clamping means 510 and this engages with the top of the pivotable support 15 in use to help secure the attachment between the apparatus 1 and attachment 501. can also be moved between a ground working configuration and a stored or transport configuration by using the winch 8. In some embodiments the attachment means and members 509, 510 can form part of the plate member 508.

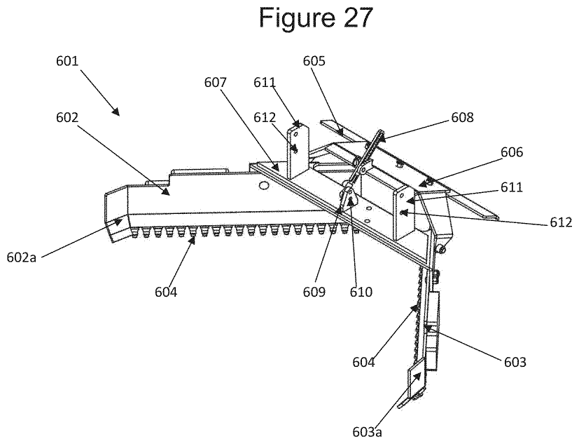

FIG. 27 shows another removable ground working apparatus namely an alternative embodiment of a road conditioning attachment 601. As shown the attachment 601 has a left blade 602 with an angled end 602a, and right blade 603 with an angled end 603a and as can be seen the blades 602, 603 have a number of teeth 604 preferably made from carbide. Those skilled in the art will appreciate that instead of teeth 604 other types of ground engaging means may be used. The attachment 601 also has an adjustable floating levelling blade/gate 605 attached to a moveable rear plate member 606 which can be moved from a dragging levelling configuration or can be moved to a stored configuration when not in use like in the figure shown. The attachment 601 also has a cross plate member 607, which is pivotally connected to the rear plate member 606 and also is connected to the blades 602, 603. The attachment 601 also has a means to adjust and lock the levelling blade/gate 608, a winch cable attachment means 609 with apertures 610 for receiving a winch cable 14 and a pair of attachment members 611 with apertures 612 for attaching to the pivotable support arms 19 of the apparatus 1. The attachment 601 is preferably about 1665 mm in width and 545 mm in height although it will be appreciated that the attachment 601 can come in different shapes and sizes. The attachment 601 can also be moved between a ground working configuration and a stored or transport configuration by using the winch 9. In some embodiments the attachment means and members 609, 610, 611, 612 can form part of the plate member 607.

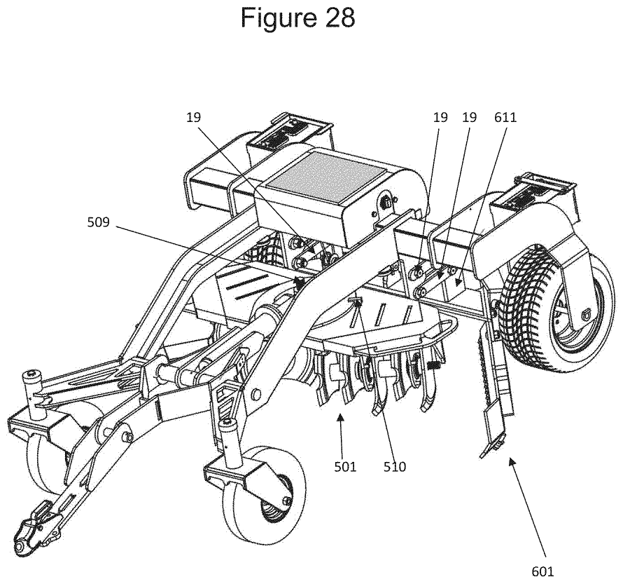

FIGS. 28-30 illustrate the attachments 501, 601 when attached to the rest of the apparatus 1. As can be seen attachment 501 is attached via the pivotable support 15 via the attachment member 509 and clamping means 510 and is supported by the winch cable 13 which attaches to the attachment member 16 on the pivotable support 15. Attachment 601 is connected to the rest of the apparatus via the attachment members 611 which are fastened to the support arms 19 of the apparatus 1 and also via winch cable 14 which is connected to the winch cable attachment means 610. In these figures the levelling blade 605 and rear plate 205 and of the attachment 601 are in the stored position/configuration. It will be appreciated that the attachments 501, 601 may be connected to the apparatus 1 by other means. The conditioner attachments 501, 601 are used for conditioning gravel and dirt roads and cutting to the bottom of corrugations and potholes. The attachments 501, 601 level, crown and mix the ripped up road material and then spread the material out evenly behind the apparatus 1.

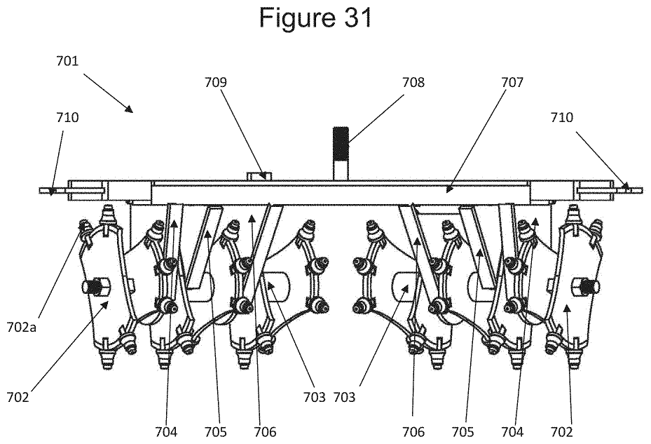

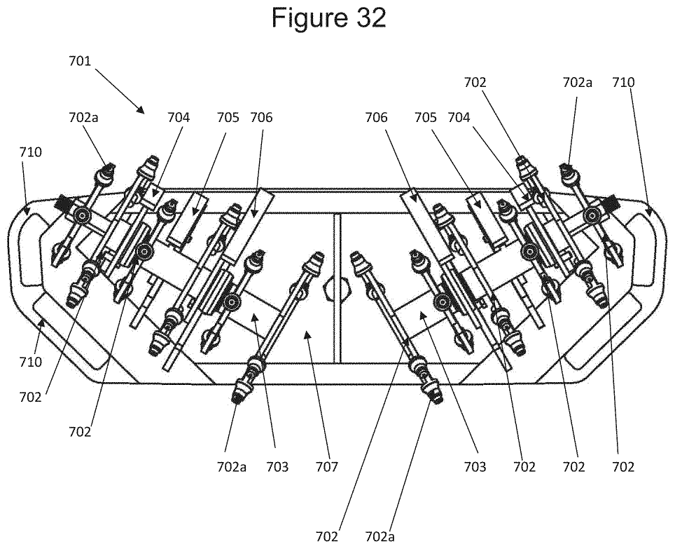

FIGS. 31 and 32 shows another removable ground working apparatus namely an alternative removable spinning blade/disc attachment 701 which forms part of an embodiment of a road conditioning attachment and may be used with the previously described attachment 601. As shown, the attachment 701 has twelve rotating blades/discs 702 with six on each side. The blades/discs 702 are from 10 mm thick Hardox 450 steel wear plate and are about 329 mm in length and 192 mm in height however are not limited to this size or shape. Three of the blades 702 have four teeth 702a and three of the blades 702 have six teeth 702a which are all preferably made from carbide. It will be appreciated that the number or location of the teeth 702a on the blades 702 can vary and although preferably made from carbide it will be appreciated that they can be made from any other suitable materials. The blades 702 have an aperture through which an elongated rotating rod (or part of the rod) 703 passes through and secured at each end e.g. with a plate and a bolt etc. it will be appreciated that other types of rotating members may be used instead of the one 703 shown and it may be secured to the blades 702 in other suitable ways and in some embodiments the blades 702 may be permanently attached to the rotating member 703. The attachment 701 also has three central links/scrapers 704, 705, 706 on each side. The rod 703 only passes through two of the central links/scrapers 704 and 706 and these links 704, 706 have bearings housed within them. One edge or face of the links 704, 705, 706 is adapted/shaped for scraping the ground. The links 704, 705, 706 are bolted to the bottom of a plate member 707 of the attachment 501 however, those skilled in the art will appreciate that they can be attached to the plate member 707 in other ways. The plate member 707 can come in different shapes and sizes and is preferably made from steel however it may be made from any suitable materials and is preferably about 365 mm in width and about 1130 mm in length. The attachment 701 also has attachment member 708, a movable clamping means 709 and as can be seen the attachment 701 has four handles 710 to assist with lifting/attaching/removing it. In some embodiments there may be more or less than three links/scrapers 704, 705, 706 and the number of housed bearings may also vary. This attachment 701 similar to attachment 101 and 501 however the number and arrangement of the blades 702 and links 704, 705, 706 differ long with the addition of teeth 702a on the discs 102. The attachment 701 is connected to the rest of the apparatus 1 via the attachment member 708 which protrudes upwardly from the roof of the plate member 707. The attachment member 708 passes through the aperture 17 in the pivotable support 15 and is then secured/attached via a bolt or the like. The attachment 701 also has a movable clamping means 709 and this engages with the top of the pivotable support 15 in use to help secure the attachment between the apparatus 1 and attachment 701. The attachment 701 can also be moved between a ground working configuration and a stored or transport configuration by using the winch 8. In some embodiments the attachment means and members 709, 709 can form part of the plate member 707.

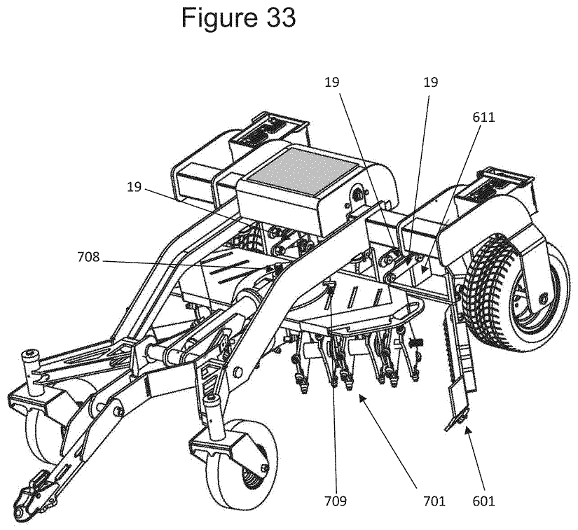

FIG. 33 shows the attachments 701, 601 when attached to the rest of the apparatus 1. As can be seen attachment 701 is attached via the pivotable support 15 via the attachment member 708 and clamping means 709 and is supported by the winch cable 13 which attaches to the attachment member 16 on the pivotable support 15. Attachment 601 is connected to the rest of the apparatus via the attachment members 611 which are fastened to the support arms 19 of the apparatus 1 and also via winch cable 14 which is connected to the winch cable attachment means 610. The conditioner attachments 601, 701 are used for conditioning gravel and dirt roads and cutting to the bottom of corrugations and potholes and are very effective on gravel roads. The attachments 601, 701 level, crown and mix the ripped up road material and then spread the material out evenly behind the apparatus 1. As the blades 702 have teeth 702a as they rotate in a forward motion they dig into the gravel road twisting sideways shattering the roads surface, the outside blades 601 also have teeth 604 attached to them dragging the loose material into the middle of the machine then it is levelled out automatically by the gate/blade 605 at the rear

The apparatus 1 can be transported to sites by either towing it via the pivoting towing attachment 5 with the ground working attachment in a stored configuration (or not attached) or it can be loaded onto a trailer and in a preferred embodiment of the invention the trailer is 2440 mm wide and 3600 mm in length and having a winch to winch the apparatus 1 on and off. The apparatus 1 can weigh between around 480 kg to around 590 kg depending on what attachments 101, 201, 301, 401, 501, 601, 701 are connected to it.

It will be appreciated that the attachments are not limited to the ones shown for example in one embodiment there may be a roller attachment. In some embodiments the apparatus 1 may have a third winch which moves the dragging or levelling rear blade between a ground working and a storage or configuration. It will also be appreciated that different combinations of attachments 101, 201, 301, 401, 501, 601, 701 may be used depending on the task required. As the attachments 101, 201, 301, 401, 501, 601, 701 can be changed by a user to perform multiple jobs on-site this saves lots of time and money as known ground working apparatus are usually specialized in addition to being very expensive. The apparatus 1 also has another advantage due to its size as known ground working apparatus are usually very large and are difficult to transport and cannot access certain areas due to their size unlike the apparatus 1 which is easy to transport and can access small areas and easy to manoeuvre. The apparatus 1 is also much cheaper to produce and has less maintenance required than known ground working machines.

It is to be understood that even though numerous characteristics and advantages of the various embodiments of the present invention have been set forth in the foregoing description, together with details of the structure and functioning of various embodiments of the invention, this disclosure is illustrative only, and changes may be made in detail so long as the functioning of the invention is not adversely affected. For example, the particular elements of the apparatus 1 may vary dependent on the particular application for which it is used without variation in the spirit and scope of the present invention. In addition, although the preferred embodiments described herein are directed to a ground working apparatus 1 with removable ground working attachments 101, 201, 301, 401, 501, 601, 701, it will be appreciated by those skilled in the art that variations and modifications are possible within the scope of the appended claims.

1. A ground working apparatus comprising:
a frame having a plurality of wheels attached;
at least one removable ground working attachment supported directly or indirectly by the frame;
a means which is adapted to move the at least one removable ground working attachment between a storage configuration and a ground working configuration; and
a vehicle connection means;
the apparatus configured such that when in use and when connected to a vehicle via the vehicle connection means movement of the attached vehicle causes the attached apparatus to move in the same direction as the attached vehicle and if the at least one removable ground working attachment is in or is moved to the ground working configuration this results in the at least one removable ground working attachment working the ground it engages with.

2. A ground working apparatus according to claim 1, having at least two removable ground working attachments such that in use a user is able to change the removable ground working attachment depending on the ground work that they wish the apparatus to perform.

3. A ground working apparatus according to claim 1, having two removable ground working attachments supported directly or indirectly by the frame and wherein the means which is adapted to move the at least one removable ground working attachment between a storage configuration and a ground working configuration is adapted to move one or both of the ground working attachments between a storage configuration and a ground working configuration and wherein the apparatus is configured such that when in use and when connected to a vehicle via the vehicle connection means movement of the attached vehicle causes the attached apparatus to move in the same direction as the attached vehicle and this also results in one or both of the removable ground working attachments working the ground they engage if they are in a ground working configuration.

4. A ground working apparatus according to claim 1, wherein the at least one removable ground working attachment is a grading attachment, a levelling attachment, a retrieving attachment, a road conditioning attachment or a rut filling attachment.

5. A ground wording apparatus according to claim 1, wherein the vehicle connection means is a towing attachment which is pivotally connected to the frame.

6. A ground working apparatus according to claim 1, wherein the means to move the ground working attachment between a storage configuration and a ground working configuration is a winching means which is supported directly or indirectly by the frame.

7. A ground working apparatus according to claim 1, wherein the means to move the ground working attachment between a storage configuration and a ground working configuration is a winching means which is supported directly or indirectly by the frame and wherein the winching means comprises a front winch and a rear winch both of which are adapted to be controlled remotely by a user.

8. A ground working apparatus according to claim 1, wherein the at least one removable ground working attachment is adapted to releasably engage directly or indirectly with the frame.

9. A ground working apparatus according to claim 1, wherein the at least one removable ground working attachment is adapted to releasably engage directly or indirectly with the means which is adapted to move the at least one ground working attachment between a storage configuration and a ground working configuration.

10. A ground working apparatus according to claim 1, wherein the apparatus has a ground working attachment support which is pivotally connected to the frame and is adapted to releasably engage with the at least one removable ground working attachment.

11. A ground working apparatus according to claim 1, wherein the apparatus has pivotable ground working attachment support arms which are pivotally connected to the frame and are adapted to releasably engage with the at least one removable ground working attachment.

12. A ground working apparatus according to claim 1, wherein the at least one removable ground working attachment has at least one blade attached directly or indirectly to a blade support means which is adapted to releasably engage with the frame of the apparatus either directly or indirectly and also adapted to releasably engage directly or indirectly with the means which is adapted to move the at least one removable ground working attachment between a storage configuration and a ground working configuration.

13. A ground working apparatus according to claim 1, wherein the at least one removable ground working attachment has a left blade with a front end and a rear end and a right blade with a front end and a rear end and the blades are attached directly or indirectly to a blade support means and wherein there is an opening between the two rear ends of the blades, and wherein the blade support means is adapted to releasably engage with the frame of the apparatus either directly or indirectly and is also adapted to releasably engage directly or indirectly with the means which is adapted to move the at least one removable ground working attachment between a storage configuration and a ground working configuration.

14. A ground working apparatus according to claim 1, wherein the at least one removable ground working attachment has a left blade, a right blade and a middle blade and the blades have a plurality of ground engaging teeth and the blades are attached directly or indirectly to a blade support means, and wherein the blade support means is adapted to releasably engage with the frame of the apparatus either directly or indirectly and is also adapted to releasably engage directly or indirectly with the means which is adapted to move the at least one removable ground working attachment between a storage configuration and a ground working configuration.

15. A ground working apparatus according to claim 1, wherein the at least one removable ground working attachment has a left blade with a front end and a rear end and a right blade with a front end and a rear end and the blades are attached directly or indirectly to a blade support means and wherein there is an opening between the two rear ends of the blades and wherein the blade support means is adapted to releasably engage with the frame of the apparatus either directly or indirectly and is also adapted to releasably engage directly or indirectly with the means which is adapted to move the at least one removable ground working attachment between a storage configuration and a ground working configuration, the attachment also having an adjustable rear dragging or levelling means which is attached directly or indirectly to the blade support means and wherein the adjustable rear dragging or levelling means is adapted such that it can be moved between a stored configuration and a dragging or levelling configuration and when in the dragging or levelling configuration this closes the opening between the two rear ends of the left and right blades.

16. A ground working apparatus according to claim 1, wherein the apparatus has pivotable ground working attachment support arms which are pivotally attached to the frame and wherein the at least one removable ground working attachment has a left blade with a front end and a rear end and a right blade with a front end and a rear end and the blades are attached directly or indirectly to a blade support means and wherein the blade support means has attachment members which are adapted to releasably engage with the pivotable ground working attachment support arms and wherein the blade support means also has a connection member which is adapted to releasably engage with the means which is adapted to move the at least one ground working attachment between a storage configuration and a ground working configuration.

17. A ground working apparatus according to claim 1, wherein the at least one removable ground working attachment has a plurality of rotatable ground engaging blades adapted to dislodge the ground and wherein the blades are supported by a rotatable ground engaging blade support means which is adapted to releasably engage with the frame directly or indirectly and to releasably engage directly or indirectly with the means which is adapted to move the at least one removable ground working attachment between a storage configuration and a ground working configuration.

18. A ground working apparatus according to claim 1, wherein the at least one removable ground working attachment has a plurality of rotatable ground engaging blades adapted to dislodge the ground and wherein the blades are supported by a rotatable ground engaging blade support means which is adapted to releasably engage with the frame directly or indirectly and to releasably engage directly or indirectly with the means which is adapted to move the at least one removable ground working attachment between a storage configuration and a ground working configuration, the removable ground working attachment also having at least one ground scraping member which is attached directly or indirectly to the rotatable ground engaging blade support means.

19. A ground working apparatus according to claim 1, wherein the at least one removable ground working attachment has a plurality of rotatable ground engaging blades with a plurality of ground engaging teeth and wherein the blades and teeth are adapted to dislodge the ground and wherein the blades and teeth are supported by a rotatable ground engaging blade support means which is adapted to releasably engage with the frame directly or indirectly and to releasably engage directly or indirectly with the means which is adapted to move the at least one removable ground working attachment between a storage configuration and a ground working configuration.

20. A ground working apparatus according to claim 1, wherein the apparatus has a pivotable ground working attachment support which is pivotally connected to the frame and wherein the at least one removable ground working attachment has a plurality of rotatable ground engaging blades adapted to dislodge the ground and wherein the blades are supported by a rotatable ground engaging blade support means and wherein the rotatable ground engaging blade support means has at least one attachment member which is adapted to releasably engage with the pivotable ground working attachment support and wherein the ground working attachment support also has connection member adapted to releasably engage with the means which is adapted to move the at least one ground working attachment between a storage configuration and a ground working configuration.

21. A removable ground working attachment for use with a ground working apparatus having a left blade with a front end and a rear end, a right blade with a front end and a rear end with an opening between the rear ends and an adjustable rear blade which is adapted to move between a stored configuration and a dragging or levelling configuration which closes the opening between the two rear ends of the left and right blades and wherein the blades are attached directly or indirectly to a blade support means which is adapted to releasably engage with the frame of an apparatus directly or indirectly and the blade support means also being adapted to releasably engage with the means which is adapted to move the at least one ground working attachment between a ground working configuration and a storage configuration.

22. A removable ground working attachment according to claim 21, further having a middle blade attached directly or indirectly to the blade support means and wherein the blades all have a plurality of ground engaging teeth.

23. A removable ground working attachment for use with a ground working apparatus having a plurality of rotatable ground engaging blades adapted to dislodge the ground and wherein the blades are supported by a rotatable ground engaging blade support means which is adapted to releasably engage with the frame of an apparatus directly or indirectly and is also adapted to releasably engage directly or indirectly with the means which is adapted to move the at least one ground working attachment between a ground working configuration and a storage configuration.

24. A removable ground working attachment according to claim 23, having at least one ground scraping member which is attached directly or indirectly to the rotatable ground engaging blade support means.

25. A removable ground working attachment according to claim 23, wherein the rotatable ground engaging blades have a plurality of ground engaging teeth.
